(19) United States
(12) Patent Application Publication
(10) Pub. No.: US 2020/0274409 A1
(43) Pub. Date: Aug. 27, 2020

(54) MOTOR AND AIR BLOWER

(71) Applicant: Nidec Corporation, Kyoto (JP)

(72) Inventors: Junya KAWATA, Kyoto (JP); Hideyuki TAKEMOTO, Kyoto (JP); Yuta YAMASAKI, Kyoto (JP); Hideki AOI, Kyoto (JP)

(21) Appl. No.: 16/751,242

(22) Filed: Jan. 24, 2020

(30) Foreign Application Priority Data
Feb. 22, 2019 (JP) 2019-030528

(51) Int. Cl. H02K 1/27; H02K 1/28; H02K 7/14; H02K 11/215; H02K 21/22; F04D 25/06; F04D 29/32

(52) U.S. Cl. CPC H02K 1/2786; H02K 1/28; H02K 7/14; F04D 29/325; H02K 21/22; F04D 25/06; H02K 11/215

(57) ABSTRACT

A motor of an outer rotor type provided in an air blower includes a rotor rotatable about a central axis extending in a vertical direction, and a stator to drive the rotor. The rotor includes a magnet on which magnetized regions including magnetic poles different from each other are alternately arranged in a circumferential direction, and a rotor yoke which is provided on a radial-directional outer surface of the magnet using a magnetic material, and includes a yoke cylinder extending in an axial direction. A cross-sectional area of the yoke cylinder viewed in the circumferential direction at a circumferential-directional position that overlaps a space between the adjacent magnetized regions in the radial direction is larger than a cross-sectional area of the yoke cylinder viewed in the circumferential direction at a circumferential-directional position that overlaps an inner portion of each magnetized region in the radial direction.

### CROSS REFERENCE TO RELATED APPLICATION

The present invention claims priority under 35 U.S.C. § 119 to Japanese Application No. 2019-030528 filed on Feb. 22, 2019, the entire contents of which are hereby incorporated herein by reference.

### FIELD OF THE INVENTION

The present disclosure relates to a motor and an air blower.

### BACKGROUND

In a rotor that faces a stator unit of a motor in a radial direction, a rotor yoke is provided in order to elicit performance of a magnet. For example, a motor of an outer rotor type in which twelve plate-shaped permanent magnets are attached to an inner circumferential surface of a large-diameter part of a rotor housing which is a cylindrical back yoke is known. The permanent magnets are arranged at equidistant intervals in the circumferential direction so as to ensure a certain interval. Furthermore, in order to reduce weight of the motor while suppressing demagnetization of the permanent magnet, in the large-diameter part of the rotor housing, a thickness of a part facing a circumferential-directional center of the permanent magnet is smaller than a thickness of a non-facing part which does not face the permanent magnet.

The rotor yoke enhances magnetic performance of the magnet by reducing magnetic resistance of a magnetic flux passing through the rotor yoke.

However, when the rotor yoke is thin, a density of the magnetic flux passing through the rotor yoke exceeds the maximum magnetic flux density allowed for the rotor yoke and thereby magnetic saturation occurs inside the rotor yoke such that there is a concern that the magnetic flux may be leaked to the outside of the rotor yoke. If the magnetic flux is leaked from the rotor yoke, magnetic performance of the magnet is not improved to the maximum such that there is a concern that the motor performance may be degraded. In addition, when the rotor yoke is made sufficiently thick to avoid saturation of the magnetic circuit, the rotor becomes heavier and thereby there is a concern that starting characteristics, and the like of the motor may be deteriorated.

### SUMMARY

A motor according to example embodiment of the present disclosure may be a motor of an outer rotor type including a rotor rotatable about a central axis extending in a vertical direction and a stator to drive the rotor. The rotor may include a magnet on which a plurality magnetized regions including magnetic poles different from each other are alternately arranged in a circumferential direction, and a rotor yoke provided on a radial-directional outer surface of the magnet using a magnetic material, the rotor yoke including a yoke cylinder extending in an axial direction. A cross-sectional area of the yoke cylinder viewed in the circumferential direction at a circumferential-directional position that overlaps a space between the adjacent magnetized regions in the radial direction is larger than a cross-sectional area of the yoke cylinder viewed in the circumferential direction at a circumferential-directional position that overlaps an inner portion of each magnetized region in the radial direction.

An air blower according to an example embodiment of the present disclosure may include the above-described motor and a moving blade rotatable about the central axis together with the rotor of the motor.

According to the example embodiments of an motor and an air blower of the present disclosure, it is possible to prevent or suppress performance deterioration of the motor caused by magnetic saturation in the rotor yoke.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of an air blower according to an example embodiment of the present disclosure.

FIG. 2 is a cross-sectional view showing a configuration example of the air blower according to an example embodiment of the present disclosure.

FIG. 3A is a cross-sectional view of a rotor yoke and a magnet according to an example embodiment of the present disclosure when viewed in an axial direction.

FIG. 3B is a cross-sectional view of the rotor yoke and the magnet according to an example embodiment of the present disclosure when viewed in a radial direction.

FIG. 4A is a conceptual diagram showing a distribution of magnetic flux passing through the rotor yoke when viewed in the axial direction.

FIG. 4B is a conceptual diagram showing a distribution of magnetic flux passing through the rotor yoke when viewed in the radial direction.

FIG. 5A is a cross-sectional view of a rotor yoke and a magnet according to a first modified example embodiment when viewed in the axial direction.

FIG. 5B is a cross-sectional view of the rotor yoke and the magnet according to the first modified example embodiment when viewed in the radial direction.

FIG. 6A is a cross-sectional view of a rotor yoke and a magnet according to a second modified example embodiment when viewed in the axial direction.

FIG. 6B is a cross-sectional view of the rotor yoke and the magnet according to the second modified example embodiment when viewed in the radial direction.

FIG. 7 is a cross-sectional view of a rotor yoke and a magnet according to a third modified example embodiment of the present disclosure when viewed in the radial direction.

### DETAILED DESCRIPTION

Hereinafter, example embodiments of the present disclosure are described with reference to the accompanying drawings.

In the present specification, with regards to the air blower 100, a direction parallel to a central axis CA is referred to as an “axial direction”. In the axial direction, a direction from a base 420 of a housing 400 to a shaft holder 211, which will be described later, is referred to as an “upward direction”, and a direction from the shaft holder 211 to the base 420 is referred to as a “downward direction”. With regards to each component, an end part in an upward direction is referred to as an “upper end part”, and a position of the upper end part in the axial direction is referred to as an “upper end”. Further, an end part in a downward direction is referred to as a “lower end part”, and a position of the lower end part in the axial direction is referred to as a “lower end”. Further, with regards to faces of components, a face oriented in the upward direction is referred to as an “upper face”, and a face oriented in the downward direction is referred to as a “lower face”.

A direction orthogonal to the central axis CA is referred to as a “radial direction”. In the radial direction, a direction approaching the central axis CA is referred to as “inwardly in the radial direction”, and a direction away from the central axis CA is referred to as “outwardly in the radial direction”. With regards to each component, a radially inward end part is referred to as a “radial-directional inner end part”, and a position of the radial-directional inner end part is referred to as a “radial-directional inner end”. Furthermore, a radially outward end part is referred to as a “radial-directional outer end part”, and a position of the radial-directional outer end part is referred to as a “radial-directional outer end”. In addition, with regards to side faces of each component, a face oriented in the inward direction is referred to as a “radial-directional inner face”, and a face oriented in the outward direction is referred to as a “radial-directional outer face”.

A direction along a circumference about the central axis CA is referred to as a “circumferential direction”. With regards to each component, an end part in the circumferential direction is referred to as “a circumferential-directional end part” and a position of the circumferential-directional end part in the circumferential direction is referred to as “a circumferential-directional end”.

In addition, in this specification, the term “annular shape” includes an arch shape having a discontinuity on a part of an entire circumference about the central axis CA, in addition to a shape that is continuously connected without any discontinuity across an entire circumference in the circumferential direction about the central axis CA.

In addition, it should be understood that the explanation described above is not strictly applied when the air blower is assembled to an actual equipment.

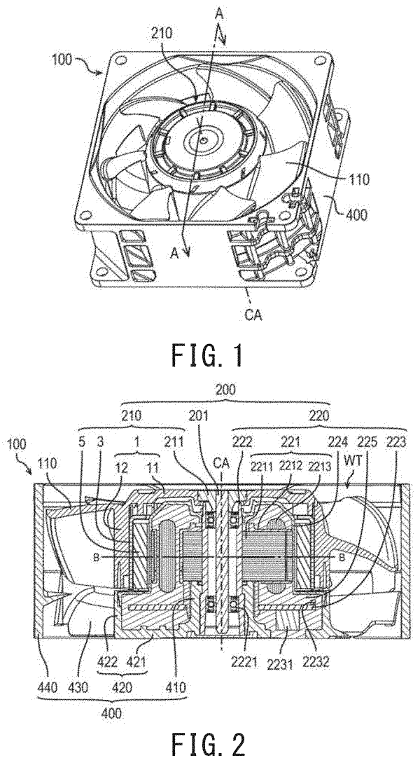

FIG. 1 is a perspective view of the air blower 100 according to an example embodiment of the present disclosure. FIG. 2 is a cross-sectional view showing a configuration example of the air blower 100 according to an example embodiment of the present disclosure. FIG. 2 is a cross-sectional view of the air blower 100 taken along line A-A in FIG. 1, and shows a cross-sectional structure of the air blower 100 in the case when the air blower 100 is cut by a virtual plane including a central axis CA.

As shown in FIGS. 1 and 2, the air blower 100 includes a moving blade 110, a motor 200 of outer rotor type, and a housing 400. The moving blade 110 is rotatable together with a rotor 210 about the central axis CA extending in a vertical direction. The moving blade 110 is integrally formed with the rotor 210 (which will be described later) of the motor 200. The motor 200 drives and rotates the moving blade 110. The housing 400 surrounds the moving blade 110 and the motor 200.

The housing 400 includes a holder supporter 410, a base 420, a rib 430, and a housing cylinder 440.

The holder supporter 410 has a cylindrical shape or a substantially cylindrical shape extending in an axial direction, and supports a bearing holder 222 (which will be described later) of the motor 200.

The base 420 has a cylindrical shape or a substantially cylindrical shape with a bottom, and includes a bottom lid 421 and an outer cylinder 422. The bottom lid 421 has a disk shape or a substantially disk shape centered on the central axis CA and having an opening at a center thereof, and is widened in a radial direction from a lower end part of the holder supporter 410. The outer cylinder 422 has a cylindrical shape or a substantially cylindrical shape extending in the upward direction from a radial-directional outer end part of the bottom lid 421.

The rib 430 connects the base 420 and the housing cylinder 440. In this example embodiment of the present disclosure, a plurality of ribs 430 are provided. A radial-directional inner end part of the rib 430 is connected to a radial-directional outer face of the base 420, and a radial-directional outer end part of the rib 430 is connected to a radial-directional inner face of the housing cylinder 440. In this example embodiment of the present disclosure, the rib 430 has a plate shape or a substantially plate shape extending in the downward direction, and is inclined in the downward direction in the fore rotational direction of the moving blade 110. The rib 430 functions as a stationary blade, and rectifies air stream flowing from an upper side to a lower side by rotation of the moving blade 110.

The housing cylinder 440 has a cylindrical shape or a substantially cylindrical shape extending in the axial direction, and holds the base 420 via the rib 430. In this example embodiment of the present disclosure, the housing cylinder 440 accommodates the moving blade 110, the motor 200, the holder supporter 410, the base 420, the rib 430, and the like therein. A wind tunnel space WT extending in the axial direction is provided between the housing cylinder 440, and a cylinder 12 (described later) of the motor 200 and the outer cylinder 422 of the housing 400. Air stream blown out in the downward direction by the moving blade 110 flows in the wind tunnel space WT.

In this example embodiment of the present disclosure, the air blower 100 of outer rotor type is an axial fan blowing air stream in the axial direction. However, the present disclosure is not limited to the example embodiment, and for example, the air blower 100 may be a centrifugal fan which blows air stream in the radial direction.

Moreover, the air blower 100 of this example embodiment of the present disclosure is a fan motor, and the moving blade 110 is a part of the same member as a holder 1 (described later) of the rotor 210. However, the present disclosure is not limited to this example embodiment, and the moving blade 110 may be a member different from the holder 1. In this case, for example, the air blower 100 may further include an impeller having the moving blade 110; and a cylindrical impeller base with the moving blade 110 being provided, which has a lid to be attached to the holder 1.

Next, a configuration of the motor 200 is described with reference to FIGS. 1 and 2. The motor 200 of outer rotor type includes a shaft 201, the rotor 210, and a stator unit 220.

The shaft 201 is a rotating shaft of the moving blade 110 and the rotor 210. The shaft 201 may be rotated about the central axis CA extending in the vertical direction together with the moving blade 110 and the rotor 210. In addition, the present disclosure is not limited to the example embodiment, and the shaft 201 may be a fixed shaft attached to a stator 221. When the shaft 201 is a fixed shaft, a bearing for the rotor 210 is provided between the shaft 201 and the rotor 210.

The rotor 210 is rotatable about the central axis CA extending in the vertical direction. The air blower 100 includes the rotor 210. The rotor 210 includes a shaft holder 211, the holder 1 having a cylindrical shape or a substantially cylindrical shape with a lid, a rotor yoke 3, and a magnet 5. The rotor yoke 3 will be described later.

The shaft holder 211 is attached to the shaft 201 at an upper part of the motor 200 in the axial direction. In this example embodiment of the present disclosure, the shaft holder 211 is attached to an axial-directional upper end part of the shaft 201 and is widened outwardly in the radial direction from a radial-directional outer face of the shaft 201.

The holder 1 holds the magnet 5. More specifically, in this example embodiment of the present disclosure, the holder 1 is made of resin and holds the magnet 5 via the rotor yoke 3. The holder 1 has a top plate 11 and a cylinder 12.

The top plate 11 has a plate shape or a substantially plate shape which is widened in the radial direction. More specifically, the top plate 11 has a disk shape or a substantially disk shape centered on the central axis CA and having an opening at a center thereof, and is widened in the radial direction from a radial-directional outer end part of the shaft holder 211.

The cylinder 12 extends in the downward direction from a radial-directional outer end part of the top plate 11. The plurality of moving blades 110 are provided on a radial-directional outer face of the cylinder 12. The rotor yoke 3 is provided on a radial-directional inner face of the cylinder 12.

The magnet 5 is disposed on a radial-directional outer side of the stator 221 and faces the stator 221 in the radial direction. A radial-directional outer side of the magnet 5 is covered with the rotor yoke 3.

In this example embodiment of the present disclosure, the magnet 5 has an annular shape or a substantially annular shape centered on the central axis CA. In this way, the magnet may generate a stronger magnetic force as compared with a configuration in which segment magnets arranged in a circumferential direction are employed and thereby may further reduce the number of components. Therefore, it is possible to reduce the number of manufacturing processes using the magnet 5. Further, for example, even if stress is applied when the magnet 5 is integrally molded with the holder 1, it is difficult for the magnet 5 to be deformed. However, the present disclosure is not limited to this example, and the magnet 5 may include a plurality segment magnets arranged in the circumferential direction.

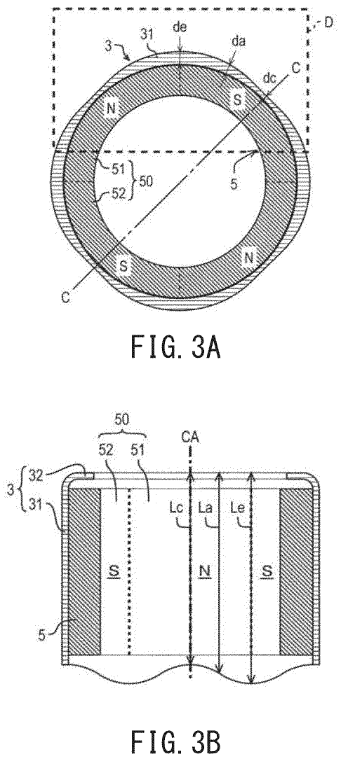

The magnet 5 has a plurality of magnetized regions 50 having different magnetic poles (see, for example, FIG. 3A described later). The magnetic poles are N and S poles. The plurality of magnetized regions 50 include a first magnetized region 51 and a second magnetized region 52. In this example embodiment of the present disclosure, the first magnetized region 51 has the N pole on a radial-directional inner face side of the magnet 5 and the second magnetized region 52 has the S pole on the radial-directional inner face side of the magnet 5. In the magnet 5, the plurality of magnetized regions 50 having different magnetic poles are alternately arranged in the circumferential direction. That is, the first magnetized regions 51 and the second magnetized regions 52 are alternately arranged in the circumferential direction.

Next, the stator unit 220 is described with reference to FIG. 2. The stator unit 220 drives the rotor 210. The air blower 100 includes the stator unit 220. The stator unit 220 includes the stator 221, a bearing holder 222, a substrate 223, a cover 224, and a resin filling part 225.

The stator 221 drives the rotor 210 to rotate the rotor 210 in the circumferential direction when the motor 200 is driven. The stator 221 has an annular shape or a substantially annular shape centered on the central axis CA, and, in this example embodiment of the present disclosure, is a laminated body in which a plurality of plate-shaped electrical steel sheets are laminated. The stator 221 includes a stator core 2211 made of a magnetic material, an insulator 2212, and a plurality of coils 2213. The plurality of coils 2213 are wound around the stator core 2211 via the insulator 2212.

The bearing holder 222 has a cylindrical shape or a substantially cylindrical shape extending in the axial direction. The bearing holder 222 supports the stator 221, and rotatably supports the shaft 201 via a bearing 2221.

The substrate 223 is electrically connected to a conducting wire of the coils 2213 and a connecting wire (not shown) drawn to the outside of the housing 400. In this example embodiment of the present disclosure, the substrate 223 is accommodated in the base 420. Various electronic components 2231 are mounted on the substrate 223, and a sensor 2232 is particularly mounted on the substrate 223.

The sensor 2232 is a magnetism-detecting element, for example, such as a Hall element and the like. The stator unit 220 further includes the sensor 2232. The sensor 2232 detects a magnetic flux. When viewed in the axial direction, the sensor 2232 overlaps the rotor yoke 3, and preferably overlaps a yoke cylinder 31 described later. In this example embodiment of the present disclosure, the sensor 2232 is provided below the rotor yoke 3. In this way, for example, a circumferential-directional position of the rotor 210 in rotation may be detected by detecting the magnetic flux leaked from the rotor yoke 3 by means of the sensor 2232 such as the Hall element. In order to detect the magnetic flux of the magnet 5 by means of the sensor 2232, therefore, there is no need to extend a length of the magnet 5 so as to bring the magnet 5 approach the sensor 2232. Therefore, it is possible to further shorten the axial-directional size of the magnet 5.

The cover 224 has a cylindrical shape or a substantially cylindrical shape with a lid and accommodates the stator 221 therein. The cover 224 covers an opening (reference number thereof is omitted) in an upper end part of the base 420.

The base 420 and the cover 224 are filled with the resin filling part 225 which covers the stator 221, the substrate 223 and the like.

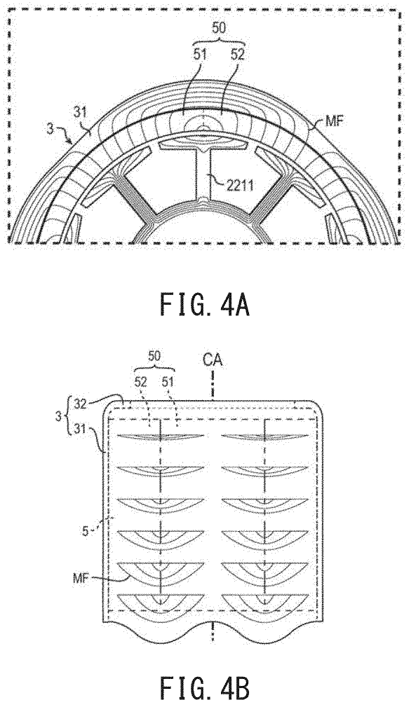

Next, a specific configuration of the rotor yoke 3 is described with reference to FIGS. 2 to 4B. FIG. 3A is a cross-sectional view of the rotor yoke 3 and the magnet 5 according to this example embodiment of the present disclosure when viewed in the axial direction. FIG. 3B is a cross-sectional view of the rotor yoke 3 and the magnet 5 according to this example embodiment of the present disclosure when viewed in the radial direction. FIG. 4A is a conceptual diagram showing a distribution of magnetic flux MF passing through the rotor yoke 3 when viewed in the axial direction. FIG. 4B is a conceptual diagram showing a distribution of the magnetic flux MF passing through the rotor yoke 3 when viewed in the radial direction. FIG. 3A is a cross-sectional view of the yoke cylinder 31 of the rotor yoke 3 and the magnet 5 taken along line B-B in FIG. 2 and shows cross-sectional structures of the yoke cylinder 31 and the magnet 5 when cut by a virtual plane perpendicular to the central axis CA. FIG. 3B is a cross-sectional view of the rotor yoke 3 and the magnet 5 taken along line C-C in FIG. 3A and shows cross-sectional structures of the rotor yoke 3 and the magnet 5 when cut by a virtual plane including the central axis CA. FIG. 4A corresponds to a cross-sectional structure of a part D surrounded by broken lines in FIG. 3A. In FIG. 4B, the magnet 5 provided on a radial-directional inner face of the yoke cylinder 31 is indicated by a broken line, and a boundary of the adjacent magnetized region 50 is indicated by a two-dot chain line.

The rotor yoke 3 is formed using a magnetic material and has a cylindrical shape or a substantially cylindrical shape extending in the axial direction. The rotor yoke 3 includes the yoke cylinder 31 and a hook 32. The yoke cylinder 31 is formed on a radial-directional outer face of the magnet 5 by using a magnetic material, and extends in the axial direction. The hook 32 extends inwardly in the radial direction from an upper end part of the yoke cylinder 31.

The magnet 5 is disposed of on the radial-directional inner face of the yoke cylinder 31. When viewed in the axial direction, the radial-directional inner face of the yoke cylinder 31 has a circular shape or a substantially cylindrical shape. In this way, for example, the cylindrical magnet 5 may be used. Therefore, it is possible to more easily attach the magnet 5 to the rotor yoke 3.

In this example embodiment of the present disclosure, the rotor yoke 3 is a laminated steel plate. The laminated steel plate is, for example, a laminated body in which a plurality of plate-shaped electrical steel sheets are laminated in the axial direction. By forming the rotor yoke 3 with the material which is the same as the material of the laminated steel plate forming the stator core 2211, for example, in a punching process, the steel plate for the stator core 2211 and the steel plate for the rotor yoke 3 may be obtained from the same steel plate material. That is, both elements may be taken together. As compared with the case where the rotor yoke 3 is manufactured in a different manufacturing process, therefore, the manufacturing process may be simplified. Furthermore, since the amount of remnants generated from the steel plate material may be reduced, it is possible to reduce the manufacturing cost. However, the present disclosure is not limited to this example, and the rotor yoke 3 may be a member obtained by processing a plate-like magnetic body into a cylindrical shape or a substantially cylindrical shape.

In this example embodiment of the present disclosure, as shown in FIG. 3A, the magnet 5 has four magnetized regions 50. In this way, a shape of the rotor yoke 3 is nearly a square shape when viewed in the axial direction. For that reason, for example, when a steel plate for the rotor yoke 3 is manufactured, it is possible to reduce the amount of remnants generated from the material. Therefore, the manufacturing cost may be further reduced. However, the present disclosure is not limited to this example, and the number of magnetized regions 50 may be an even number other than four (4). That is, the number of each of the first magnetized region 51 and the second magnetized region 52 may be a singular number or plural numbers equal to or greater than 3.

The rotor yoke 3 is held by the holder 1. The rotor yoke 3, in particular, the yoke cylinder 31 may be a member which differs from the holder 1. For example, the rotor yoke 3 may be fitted into the holder 1 in a process which is different from a molding process of the holder 1. In this way, the shape of the holder 1 may be simplified such that a design and manufacture of the holder 1 may be more easily implemented. Further, since a degree of freedom for designing the rotor yoke 3 may be improved, it is easy to obtain an ideal magnetic circuit.

Alternatively, the rotor yoke 3, particularly the yoke cylinder 31, may be a part of the holder 1. For example, the holder 1 may further include at least the yoke cylinder 31. In this configuration, the yoke cylinder 31 extends in the downward direction from the radial-directional outer end part of the top plate 11, and the top plate 11 and the yoke cylinder 31 are provided by using a magnetic material. Furthermore, the magnet 5 is provided on the radial-directional inner face of the yoke cylinder 31, and the cylinder 12 made of resin is provided on a radial-directional outer face of the yoke cylinder 31. The moving blade 110 is provided on the radial-directional outer face of the cylinder 12. Such a configuration may be realized, for example, by providing the cylinder 12 made of resin on a radial-directional outer face of the rotor yoke 3 having a cylindrical shape or a substantially cylindrical shape with a lid by an insert molding process or the like. In this way, since a cylindrical part of the holder 1 may become thinner while maintaining the strength, the radial size of the holder 1 may become smaller. For that reason, for example, when the motor 200 is mounted on the air blower 100, the wind tunnel space (WT) of the air blower 100 may be further enlarged.

A cross-sectional shape of the rotor yoke 3 viewed in the circumferential direction is changed according to the circumferential-directional position. More specifically, a cross-sectional area of the yoke cylinder 31 viewed in the circumferential direction at a circumferential-directional position that overlaps a space between the adjacent magnetized regions 50 of the magnet 5 in the radial direction is larger than a cross-sectional area of the yoke cylinder 31 viewed in the circumferential direction at a circumferential-directional position that overlaps an inner part of each magnetized region 50 of the magnet 5 in the radial direction.

In the yoke cylinder 31, the magnetic flux MF at the circumferential-directional position overlapping the space between the adjacent magnetized regions 50 in the radial direction is greater than the magnetic flux MF at the circumferential-directional position overlapping an inner part of each magnetized region 50 in the radial direction. For that reason, as shown in FIGS. 4A and 4B, a cross-sectional area of the yoke cylinder 31 viewed in the circumferential direction is changed as described above. Due to the above, a density of the magnetic flux MF in the yoke cylinder 31 may be reduced, and it is possible to suppress or prevent magnetic saturation in the rotor yoke 3. Accordingly, it is possible to reduce magnetic resistance of the magnetic circuit of the magnetic flux MF passing through the inside of the yoke cylinder 31 and thereby sufficiently elicit the performance of the magnet 5. Therefore, it is possible to suppress or prevent performance deterioration of the motor 200 and the air blower 100 due to the magnetic saturation in the rotor yoke 3.

Furthermore, as the circumferential-directional position is directed from a circumferential-directional central part of each magnetized region 50 of the magnet 5 towards a circumferential-directional end part of the above magnetized region 50, the cross-sectional area of the yoke cylinder 31 viewed in the circumferential direction is preferably changed continuously. The magnetic flux MF passing through the inside of the yoke cylinder 31 is the smallest at the circumferential-directional position that overlaps the circumferential-directional central part of the magnetized region 50 in the radial direction, and is gradually increased as the circumferential-directional position is directed towards the circumferential-directional end part of the magnetized region 50. Therefore, since the cross-sectional area of the yoke cylinder 31 is continuously changed as described above when viewed in the circumferential direction, performance of the magnet 5 may be elicited more efficiently.

Furthermore, in this example embodiment of the present disclosure, even at the circumferential-directional position overlapping the circumferential-directional central part of each magnetized region 50 in the radial direction and even at the circumferential-directional position overlapping a part between one circumferential-directional end part of the first magnetized region 51 and the other circumferential-directional end part of the second magnetized region 52 adjacent to the above first magnetized region 51, the cross-sectional area of the yoke cylinder is continuously changed when viewed in the circumferential direction. However, the present disclosure is not limited to this example embodiment, and at the above-mentioned circumferential-directional position, the cross-sectional area of the yoke cylinder 31 may be discontinuously changed when viewed in the circumferential direction.

In this example embodiment of the present disclosure, in addition, an axial-directional width La of the yoke cylinder 31 is changed according to the circumferential-directional position. More specifically, as shown in FIG. 3B, an axial-directional width Le of the yoke cylinder 31 at the circumferential-directional position overlapping a space between the adjacent magnetized regions 50 of the magnet 5 in the radial direction is greater than an axial-directional width of the yoke cylinder 31 at the circumferential-directional position overlapping an inner part of each magnetized region 50 of the magnet 5 in the radial direction. The axial-directional width La of the yoke cylinder 31 becomes the widest axial-directional width Lc at the circumferential-directional position overlapping a space between the adjacent magnetized regions 50 in the radial direction, and becomes the narrowest axial-directional width Le at the circumferential-directional position overlapping a circumferential-directional central part of each magnetized region 50 in the radial direction. In this way, performance of the magnet 5 may be sufficiently elicited, and it is possible to reduce the increase in the inertia of the rotor yoke 3, that is, the moment of inertia. Therefore, it is possible to suppress deterioration of an operation characteristic, in particular, deterioration of a starting characteristic of the motor 200, while suppressing or preventing performance deterioration of the motor 200 due to magnetic saturation in the rotor yoke 3.

Further, preferably, as shown in FIG. 3B, as the circumferential-directional position is directed from the circumferential-directional central part of each magnetized region of the magnet 5 towards the circumferential-directional end part of the above magnetized region 50, the axial-directional width La of the yoke cylinder 31 is continuously changed. As described above, the magnetic flux MF in the yoke cylinder 31 is the smallest at the circumferential-directional position overlapping the circumferential-directional central part of the magnetized region in the radial direction, and is gradually increased as the circumferential-directional position is directed towards the circumferential-directional end part of the magnetized region 50. For that reason, since the axial-directional width La of the yoke cylinder 31 is continuously changed as described above, for example, as shown in FIG. 4B, overcrowding of the magnetic flux MF in the yoke cylinder 31 may be suppressed such that performance of the magnet 5 may be elicited more efficiently. Therefore, it is possible to more efficiently suppress or prevent performance deterioration of the motor 200 due to the magnetic saturation in the rotor yoke 3. In addition, even when the axial-directional width of the yoke cylinder 31 is changed in the circumferential direction, the change in inertia acting on the rotor 210 is small such that it is possible to further suppress deterioration of an operation characteristic, particularly deterioration of the starting characteristic of the motor 200.

In addition, in FIG. 3B, even at a circumferential-directional position overlapping the circumferential-directional central part of each magnetized region 50 in the radial direction and even at a position overlapping a part between the one circumferential-directional end part of the first magnetized region 51 and the other circumferential-directional end part of the second magnetized region 52 adjacent to the above first magnetized region 51 in the radial direction, the axial-directional width La of the yoke cylinder 31 is continuously changed. However, the present disclosure is not limited to the example in FIG. 3B, and at the above-mentioned circumferential-directional position, the axial-directional width La of the yoke cylinder 31 may be discontinuously changed.

In this example embodiment of the present disclosure, an axial-directional position of a lower end of the yoke cylinder 31 is changed according to the circumferential-directional position. The lower end of the yoke cylinder 31 is below a lower end of the magnet 5. As the circumferential-directional position is directed from the circumferential-directional central part of each magnetized region 50 of the magnet 5 towards the circumferential-directional end part of the above magnetized region 50, the axial-directional position of the lower end of the yoke cylinder 31 is changed in the downward direction, and preferably, is continuously changed. More specifically, in a circumferential-directional range from the circumferential-directional central part towards the circumferential-directional end part of each magnetized region 50, the axial-directional position of the lower end of the yoke cylinder 31 may be disposed farthest in the upward direction at the circumferential-directional position overlapping the circumferential-directional central part of the magnetized region in the radial direction, and is disposed farthest in the downward direction at the circumferential-directional position overlapping the circumferential-directional end part of the magnetized region 50 in the radial direction. In this way, the axial-directional width La of the yoke cylinder 31 may be changed by changing the axial-directional position of the lower end of the yoke cylinder 31 in accordance with the circumferential-directional position. Accordingly, saturation of the density of the magnetic flux MF in the rotor yoke 3 may be sufficiently suppressed.

In this example embodiment of the present disclosure, an axial-directional position of the upper end of the yoke cylinder is constant regardless of the circumferential-directional position. However, the present disclosure is not limited to this example, and the axial-directional position of the upper end of the yoke cylinder 31 may be changed according to the circumferential-directional position, and preferably, may be continuously changed. More specifically, in the circumferential-directional range from the circumferential-directional central part of each magnetized region 50 towards the circumferential-directional end part of the above magnetized region 50, the axial-directional position of the upper end of the yoke cylinder 31 may be disposed farthest in the downward direction at the circumferential-directional position overlapping the circumferential-directional central part of the magnetized region 50 in the radial direction, and may be disposed farthest in the upward direction at the circumferential-directional position overlapping the circumferential-directional end part of the magnetized region 50 in the radial direction.

That is, the axial-directional position of at least one of the upper end and the lower end of the yoke cylinder 31 may be changed according to the circumferential-directional position, and preferably, may be continuously changed.

In addition, a radial-directional width da of the yoke cylinder 31 is changed according to the circumferential-directional position. More specifically, as shown in FIG. 3A, a radial-directional width de of the yoke cylinder 31 at the circumferential-directional position overlapping a space between the adjacent magnetized regions 50 of the magnet 5 in the radial direction de is greater than a radial-directional width of the yoke cylinder 31 at the circumferential-directional position overlapping an inner part of each magnetized region 50 of the magnet 5 in the radial direction. In other words, the radial-directional width da of the yoke cylinder 31 becomes the widest radial-directional width de at the circumferential-directional position overlapping a space between the adjacent magnetized regions 50 in the radial direction, and becomes the narrowest radial-directional width dc at the circumferential-directional position overlapping a circumferential-directional central part of each magnetized region 50 in the radial direction. Further, preferably, as the circumferential-directional position is directed from the circumferential-directional central part of each magnetized region 50 towards the circumferential-directional end part of the above magnetized region 50, the radial-directional width da of the yoke cylinder 31 is continuously changed. In this way, by changing the radial-directional width da of the yoke cylinder 31 according to the circumferential-directional position, for example, as shown in FIG. 4A, overcrowding of the magnetic flux MF in the yoke cylinder 31 may be suppressed such that performance of the magnet 5 may be elicited more sufficiently.

In addition, in FIG. 3A, even at a circumferential-directional position overlapping the circumferential-directional central part of each magnetized region 50 in the radial direction and even at a position overlapping a part between the one circumferential-directional end part of the first magnetized region 51 and the other circumferential-directional end part of the second magnetized region 52 adjacent to the above first magnetized region 51 in the radial direction, the radial-directional width da of the yoke cylinder 31 is continuously changed. However, the present disclosure is not limited to the example in FIG. 3A, and at the above-mentioned circumferential-directional position, the radial-directional width da of the yoke cylinder 31 may be discontinuously changed.

In the above-described example embodiment of the present disclosure, the axial-directional width La and the radial-directional width da of the yoke cylinder 31 are changed according to the circumferential-directional position. By changing both the widths, the increase in the axial-directional lengths of the motor 200 and the air blower 100, and the increase in the inertia of the rotor 210 in rotation may be suppressed in a favorable balanced state according to the increase in the axial-directional length of the yoke cylinder 31, and thereby performance of the magnet 5 may be sufficiently elicited. However, the present disclosure is not limited to the above-described example embodiment, and as will be described below, any one of the axial-directional width La and the radial-directional width da of the yoke cylinder 31 may be changed according to the circumferential-directional position.

Below, a first to third modified example embodiments of the example embodiment of the present disclosure are described. In the description below, modified configurations of the above example embodiment, which differ from those of the above-described example embodiment, will be described. In addition, in the description below, a component which is the same as that in the above-described example embodiment is represented by the same reference numeral, and a description thereof may be omitted.

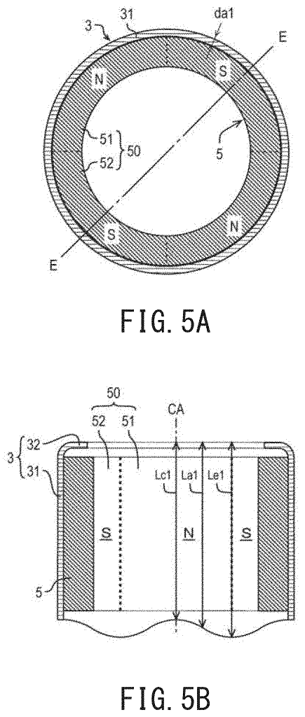

FIG. 5A is a cross-sectional view of the rotor yoke 3 and the magnet 5 according to the first modified example embodiment when viewed in the axial direction. FIG. 5B is a cross-sectional view of the rotor yoke 3 and the magnet 5 according to the first modified example embodiment when viewed in the radial direction. FIG. 5A corresponds to a cross-sectional view of the yoke cylinder 31 of the rotor yoke 3 and the magnet 5 taken along line B-B in FIG. 2, and shows cross-sectional structures of the yoke cylinder 31 and the magnet 5 when cut by a virtual plane perpendicular to the central axis CA. FIG. 5B is a cross-sectional view of the rotor yoke 3 and the magnet 5 taken along line E-E of FIG. 5A, and shows cross-sectional structures of the rotor yoke 3 and the magnet 5 when cut by a virtual plane including the central axis CA.

In the first modified example embodiment, as shown in FIGS. 5A and 5B, an axial-directional width La1 of the yoke cylinder 31 is changed according to the circumferential-directional position as in the above-described example embodiment. In other words, the axial-directional width La1 of the yoke cylinder 31 becomes the widest axial-directional width Le1 at the circumferential-directional position overlapping a space between the adjacent magnetized regions 50 of the magnet 5 in the radial direction, and becomes the narrowest axial-directional width Lc1 at the circumferential-directional position overlapping the circumferential-directional central part of each magnetized region 50 in the radial direction. Meanwhile, as shown in FIG. 5A, a radial-directional width da1 of the yoke cylinder 31 is constant regardless of the circumferential-directional position.

Even in this case, since a cross-sectional area of the yoke cylinder 31 viewed in the circumferential direction may be changed according to the circumferential-directional position in the same manner as in the above-described example embodiment, density of the magnetic flux MF in the yoke cylinder 31 may be reduced so as to suppress overcrowding of the magnetic flux MF. Accordingly, it is possible to reduce magnetic resistance of the magnetic circuit of the magnetic flux MF passing through the inside of the yoke cylinder 31, and thereby to sufficiently elicit performance of the magnet 5. As a result, it is possible to suppress or prevent performance deterioration of the motor 200 and the air blower 100 due to magnetic saturation in the rotor yoke 3. Furthermore, the increase in the inertia of the rotor yoke 3, that is, the increase in the moment of inertia may be reduced. Accordingly, it is possible to suppress deterioration of the operation characteristics of the motor 200, in particular, deterioration of the starting characteristics.

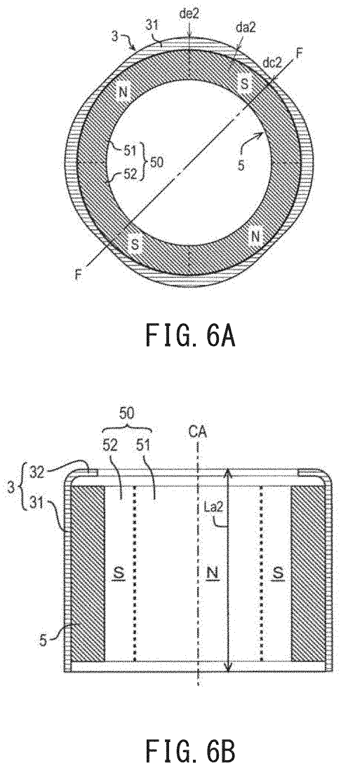

FIG. 6A is a cross-sectional view of the rotor yoke 3 and the magnet 5 according to a second modified example embodiment when viewed in the axial direction. FIG. 6B is a cross-sectional view of the rotor yoke 3 and the magnet 5 according to the second modified example embodiment when viewed in the radial direction. FIG. 6A corresponds to a cross-sectional view of the yoke cylinder 31 of the rotor yoke 3 and the magnet 5 taken along line B-B in FIG. 2, and shows the cross-sectional structures of the yoke cylinder 31 and the magnet 5 when cut by a virtual plane perpendicular to the central axis CA. FIG. 6B is a cross-sectional view of the rotor yoke 3 and the magnet 5 taken along line F-F in FIG. 6A, and shows cross-sectional structures of the rotor yoke 3 and the magnet 5 when cut by a virtual plane including the central axis CA.

In a second modified example embodiment, as shown in FIG. 6B, an axial-directional width La2 of the yoke cylinder 31 is constant regardless of the circumferential-directional position. Meanwhile, as shown in FIG. 6A, a radial-directional width da2 of the yoke cylinder 31 is changed according to the circumferential-directional position as in the above-described example embodiment. In other words, the radial-directional width da2 of the rotor yoke becomes the widest radial-directional width de2 at the circumferential-directional position overlapping a space between the adjacent magnetized regions 50 of the magnet 5 in the radial direction, and becomes the narrowest radial-directional width dc2 at the circumferential-directional position overlapping the circumferential-directional central part of each magnetized region 50 of the magnet 5 in the radial direction.

Even in this case, since a cross-sectional area of the yoke cylinder 31 viewed in the circumferential direction may be changed according to the circumferential-directional position in the same manner as in the above-described example embodiment, density of the magnetic flux MF in the yoke cylinder 31 may be reduced so as to suppress overcrowding of the magnetic flux MF. Accordingly, it is possible to reduce magnetic resistance of the magnetic circuit of the magnetic flux MF passing through the inside of the rotor yoke 3, and to sufficiently elicit performance of the magnet 5. Therefore, it is possible to suppress or prevent performance deterioration of the motor 200 and the air blower 100 due to magnetic saturation in the rotor yoke 3.

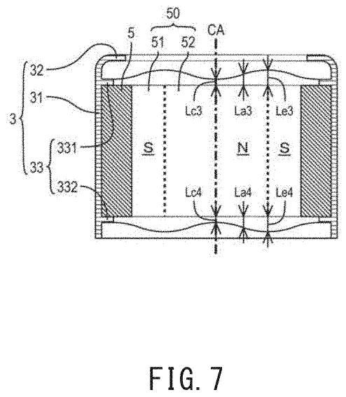

FIG. 7 is a cross-sectional view of the rotor yoke 3 and the magnet 5 according to a third modified example embodiment when viewed in the radial direction. FIG. 7 shows cross-sectional structures of the rotor yoke 3 and the magnet 5 when cut by a virtual plane including the central axis CA, like FIGS. 3B, 5B, and 6B.

In addition to the yoke cylinder 31 and the hook 32, the rotor yoke 3 further includes a yoke piece 33. In FIG. 7, the yoke piece 33 is provided on an upper face and a lower face of the magnet 5. However, the present disclosure is not limited to the example in FIG. 7, and the yoke piece 33 may be provided on one of the upper face and the lower face of the magnet 5. That is, the yoke piece 33 may be provided on at least one of the upper face and the lower face of the magnet 5. In this way, magnetic resistance of the magnetic circuit of the magnetic flux MF passing in at least one direction of the upward direction and the downward direction of the magnet 5 may be reduced by the yoke piece 33. Since performance of the magnet 5 may be further elicited, for example, the axial size of the magnet 5 may be further reduced.

The yoke piece 33 includes a first yoke piece 331 and a second yoke piece 332. The first yoke piece 331 and the second yoke piece 332 protrude inwardly in the radial direction from the radial-directional inner face of the yoke cylinder 31. The first yoke piece 331 is provided on the upper face of the magnet 5 and covers at least a radial-directional outer end part of the upper face. The second yoke piece 332 is provided on the lower face of the magnet 5 and covers at least a radial-directional outer end part of the lower face.

A radial-directional width of each of the first yoke piece 331 and the second yoke piece 332 is half of or less than a thickness of the magnet 5. In this way, via the first yoke piece 331 and the second yoke piece 332, it is possible to prevent the magnetic circuit in which the magnetic flux MF is directed from one of the radial-directional inner face and the radial-directional outer face of the magnet 5 towards the other one, from being formed.

In addition, an axial-directional width La3 of the first yoke piece 331 and an axial-directional width La4 of the second yoke piece 332 are changed according to a circumferential-directional position.

More specifically, as the circumferential-directional position is directed from the circumferential-directional central part of each magnetized region 50 of the magnet 5 towards the circumferential-directional end part, an axial-directional position of an upper end of the first yoke piece 331 is changed in the upward direction, and preferably, is continuously changed. Due to such a change in the axial-directional position of the upper end, the axial-directional width La3 of the first yoke piece 331 is widened as the circumferential-directional position is directed from the circumferential-directional central part of the magnetized region 50 toward the circumferential-directional end part. That is, since at the circumferential-directional position that overlaps the circumferential-directional central part of the magnetized region 50 in the radial direction in the above-described circumferential-directional range, the magnetic flux MF passing through the inside of the first yoke piece 331 becomes the minimum, the axial-directional width La3 becomes the narrowest axial-directional width Lc3. Meanwhile, since at the circumferential-directional position that overlaps the circumferential-directional end part of the magnetized region 50 in the radial direction in the above-described circumferential-directional range, the magnetic flux MF passing through the inside of the first yoke piece 331 becomes the maximum, the axial-directional width La3 becomes the widest axial-directional width Le3. Accordingly, saturation of density of the magnetic flux MF in the first yoke piece 331 may be sufficiently suppressed.

Further, as the circumferential-directional position is directed from the circumferential-directional central part of each magnetized region 50 of the magnet 5 towards the circumferential-directional end part, an axial-directional position of a lower end of the second yoke piece 332 is changed in the downward direction, and preferably, is continuously changed. Due to such a change in the axial-directional position of the lower end, the axial-directional width La4 of the second yoke piece 332 is widened as the circumferential-directional position is directed from the circumferential-directional central part of the magnetized region 50 toward the circumferential-directional end part. That is, since at the circumferential-directional position that overlaps the circumferential-directional central part of the magnetized region 50 in the radial direction in the above-described circumferential-directional range, the magnetic flux MF passing through the inside of the second yoke piece 332 becomes the minimum, the axial-directional width La4 becomes the narrowest axial-directional width Lc4. Meanwhile, since at the circumferential-directional position that overlaps the circumferential-directional end part of the magnetized region 50 in the radial direction in the above-described circumferential-directional range, the magnetic flux MF passing through the inside of the second yoke piece 332 becomes the maximum, the axial-directional width La4 becomes the widest axial-directional width Le4. Accordingly, saturation of density of the magnetic flux MF in the second yoke piece 332 may be sufficiently suppressed.

Furthermore, in FIG. 7, even at the circumferential-directional position overlapping the circumferential-directional central part of each magnetized region 50 in the radial direction and even at the circumferential-directional position overlapping a part between one circumferential-directional end part of the first magnetized region 51 and the other circumferential-directional end part of the second magnetized region 52 adjacent to the first the magnetized region 51 in the radial direction, the axial-directional width La3 of the first yoke piece 331 and the axial-directional width La4 of the second yoke piece 332 are continuously changed. However, the present disclosure is not limited to the example embodiment of FIG. 7, and at the above-described circumferential-directional position, at least one of the axial-directional width La3 and the axial-directional width La4 may be discontinuously changed.

The present disclosure is effective for the motor in which the magnet facing the stator unit in the radial direction is held on the holder via the rotor yoke, and the device with the motor being provided.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor of an outer rotor type comprising:
a rotor rotatable about a central axis extending in a vertical direction; and
a stator to drive the rotor; wherein
the rotor includes:
a magnet on which a plurality of magnetized regions including magnetic poles different from each other are alternately arranged in a circumferential direction; and
a rotor yoke provided on a radial-directional outer surface of the magnet using a magnetic material, the rotor yoke including a yoke cylinder extending in an axial direction;
a cross-sectional area of the yoke cylinder viewed in the circumferential direction at a circumferential-directional position that overlaps a space between the adjacent magnetized regions in the radial direction is larger than a cross-sectional area of the yoke cylinder viewed in the circumferential direction at a circumferential-directional position that overlaps an inner portion of each of the magnetized regions in the radial direction.

2. The motor of claim 1, wherein the magnet has an annular or a substantially annular shape centered about the central axis.

3. The motor of claim 1, wherein an axial-directional width of the yoke cylinder at the circumferential-directional position overlapping a space between the adjacent magnetized regions in the radial direction is greater than the axial-directional width of the yoke cylinder at the circumferential-directional position overlapping an inner portion of each of the magnetized regions in the radial direction.

4. The motor of claim 3, wherein as the circumferential-directional position extends from a circumferential-directional central portion of each of the magnetized regions towards a circumferential-directional end portion of each of the magnetized regions, the axial-directional width of the yoke cylinder is continuously changed.

5. The motor of claim 1, wherein as the circumferential-directional position extends from a circumferential-directional central portion of each of the magnetized regions towards a circumferential-directional end portion of each of the magnetized regions, a cross-sectional area of the yoke cylinder viewed in the circumferential direction is continuously changed.

6. The motor of claim 1, wherein a lower end of the yoke cylinder is below a lower end of the magnet, and as the circumferential-directional position extends from the circumferential-directional central portion of each of the magnetized regions towards the circumferential-directional end portion of each of the magnetized regions, an axial-directional position of the lower end of the yoke cylinder is changed in the downward direction.

7. The motor of claim 1, wherein the rotor further comprises a holder to hold the magnet, and the yoke cylinder is separate from the holder.

8. The motor of claim 1, wherein the rotor includes a holder to hold the magnet, and the yoke cylinder is a part of the holder.

9. The motor of claim 1, wherein the rotor yoke includes a yoke piece on at least one of an upper surface and a lower surface of the magnet.

10. The motor of claim 1, wherein a radial-directional width of the yoke cylinder at the circumferential-directional position overlapping a space between the adjacent magnetized regions in the radial direction is greater than a radial-directional width of the yoke cylinder at the circumferential-directional position overlapping an inner portion of each of the magnetized regions in the radial direction.

11. The motor of claim 1, wherein a radial-directional inner surface of the yoke cylinder has a circular or a substantially circular shape when viewed in the axial direction.

12. The motor of claim 1, wherein the rotor yoke includes a laminated steel plate.

13. The motor of claim 1, wherein the magnet includes four magnetized regions.

14. The motor of claim 1, wherein the stator includes a sensor to detect a magnetic flux, and the sensor overlaps the rotor yoke when viewed in the axial direction.

15. An air blower comprising:
the motor according to claim 1; and
a moving blade rotatable about the central axis together with the rotor of the motor.
